(19) United States
(12) Patent Application Publication
(10) Pub. No.: US 2013/0254027 A1
(43) Pub. Date: Sep. 26, 2013

(54) SYSTEM AND METHOD FOR EVENT EXPERIENCE ANALYSIS AND CORRELATION

(71) Applicants: Steven N. Silverman, Snoqualmie, WA (US); Hartwig Huemer, Mt. Horeb, WI (US)

(72) Inventors: Steven N. Silverman, Snoqualmie, WA (US); Hartwig Huemer, Mt. Horeb, WI (US)

(21) Appl. No.: 13/435,439

(22) Filed: Mar. 30, 2012

Related U.S. Application Data
(60) Provisional application No. 61/470,286, filed on Mar. 31, 2011.

(51) Int. Cl. G06Q 30/02

(52) U.S. Cl. CPC G06Q 30/0255
USPC 705/14.53

(57) ABSTRACT

Techniques for providing online experiences based on onsite visitor experiences are described. Some embodiments include a system configured to receive expressions of interest by visitors with respect to points of interest within a venue, and then later to provide those visitors with additional information related to the points of interest. In one embodiment, each point of interest in a venue is associated with a scanning station that can read a bar code presented by a visitor. In another embodiment, visitors use mobile devices (e.g., smart phones) to scan barcodes associated with points of interest or to transmit GPS coordinates of their locations as they interact with a point of interest.

### PRIORITY CLAIM

This application claims the benefit of U.S. Provisional Application Ser. No. 61/470,286 filed Mar. 31, 2011, the contents of which are incorporated by reference.

### FIELD OF THE INVENTION

The present disclosure relates to a service that provides a unified assembly of hardware, software and management systems, tools and processes to enable venues to create new visitor experiences and extend those experiences beyond the boundaries of the venue's location over time and space.

### BACKGROUND OF THE INVENTION

Venues are organizations that create location- and/or time-based experiences or special events. Venues often intend for their experiences and events to meet one or more of the following objectives: (1) engage visitors deeply in the experience or event, (2) provide exposure for underwriters, sponsors, and advertisers, (3) drive marketing, revenue and other business objectives, and (4) understand how their efforts are working to improve future business decisions. Usually this management effort requires extensive coordination, especially when considering both onsite experiences (i.e., those that visitors attend at a given place and time) and online experiences (i.e., those that visitors can experience remotely, such as on the Internet).

### SUMMARY OF THE INVENTION

Referring to FIG. 1, one embodiment of the invention is designed around four types of users: an administrator 22; a client or venue owner 24 (venue owner); a sponsor, partner, advertiser, and/or content provider 26 (sponsor); and a consumer or visitor 28 (visitor).

From a business perspective, embodiments of the invention provide a marketing, promotional, educational, and research system that can be used across industries in numerous usage environments. From a consumer perspective, embodiments provide an interactive experience that takes place at a venue and online.

More specifically, while at a venue or event 30, visitors 28 receive a barcode 34 on a card 37 (or downloaded to a mobile device 43). Throughout the venue, visitors 28 can scan their codes 34 at experience stations 36 they find at points of interest to them, such as exhibits, spaces, artists, etc. Scanning the code 34 creates a bookmark that identifies their interest in the location. Later, the visitor 28 can log into a personal website 38 that is created dynamically or “on-the-fly” to receive content based on the bookmarked locations. Additionally, a visitor 28 can download an application to his own mobile device 43 and use that device to scan codes posted throughout the venue 30. The visitor 28 may then have mobile access to content like that on their personal website 38.

Some embodiments of the invention described here include a distinct, integrated system that enables a venue 30 to extend and expand its onsite experiences to online experiences, while also addressing objectives such as those listed above. Embodiments of the invention engage visitors 28 at the venue 30, provide sponsorship opportunities, drive business objectives, and provide tools to analyze business performance.

One embodiment of the current invention combines existing and customized hardware and software technologies including:
Printed and Electronic Identification Codes 34
Barcode 34 generation software
Electronic Barcode readers 132 and software
Interactive Experience Stations 36 (aka, electronic kiosks)
Interactive experience software
Tablet PC computers 130 and mobile communication devices 43
Computer Networking and communications systems
Database, Web and e-commerce infrastructure
Sponsorship and advertising electronic purchase and placement system
Administration and management Portal software for clients, Sponsors 26, and Administrator 22s
Survey and behavioral data collection systems and software
Content management system
Data analysis software

### BRIEF DESCRIPTION OF THE DRAWINGS

Preferred and alternative examples of the present invention are described in detail below with reference to the following drawings:

FIG. 1 is an experience schematic according an embodiment of the present invention;

FIG. 2 is a chart of onsite experience processes according to an embodiment of the present invention;

FIG. 3 is a chart of visitor and sponsor portal processes according to an embodiment of the present invention;

FIG. 4 is a chart of administrator processes according to an embodiment of the present invention;

FIG. 5 is an online flowchart schematic according to an embodiment of the present invention;

FIG. 6 is an onsite process flowchart according to an embodiment of the present invention;

FIG. 7 is an onsite flowchart schematic according to an embodiment of the present invention;

FIG. 8 is a barcode and card/mobile device creation flowchart according to an embodiment of the present invention;

FIG. 9 shows exemplar experience card images according to an embodiment of the present invention;

FIG. 10 shows an exemplar mobile device according to an embodiment of the present invention;

FIG. 11 is an onsite interaction flowchart according to an embodiment of the present invention;

FIG. 12 shows an exemplar experience station according to an embodiment of the present invention;

FIG. 13 is a sponsor process flowchart according to an embodiment of the present invention;

FIG. 14 shows an exemplar venue owner, sponsor, network administrator portal according to an embodiment of the present invention;

FIG. 15 is a visitor portal schematic according to an embodiment of the present invention;

FIG. 16 shows an exemplar visitor portal according to an embodiment of the present invention; and

FIG. 17 is a network administration schematic according to an embodiment of the present invention.

### DETAILED DESCRIPTION OF THE PREFERRED EMBODIMENT

### Architectural Foundations of the Invention

Table 1 lists online and hardware platforms, software and systems and the major function that each supports in the context of embodiments of the present invention. The table shown here is based on open source solutions and is prototypical of the components and systems that may be used, in that the invention can perform similar functions on a range operating systems and hardware form factors. The invention operates on, without limitation, Android, Linux, Microsoft and Apple platforms. The code 34 that drives the major functions is uniquely created to deliver the solution as described in the rest of this document.

TABLE 1

| Online Platforms, | |
|---|---|
| Software, and Systems | Major Function |
| PHP | As a front end server side scripting |
| MYSQL | As a database back end. |
| Apache | A Web server running on Linux |
| | or windows |
| J query | For client side scripting |
| PHP Mailer | For communication over e-mails |
| Easy PDF or FPDF | For exporting reports to PDF |
| Google Analytics | For tracking the user's behaviors on line |
| Google API | For pulling the analytics data from |
| | Google to our DB |
| Google Charts or | For showing the charts |
| J Query Charts | |
| CMS Made simple or | CMS tools in PHP for designing |
| Drupal or Joomla! | dashboards and ad package templates |
| Flow player or | For embedding the videos in portal |
| You tube Player | |
| QR code 34 | For generating 2D barcode34 |
| Experience Station 36 and | |
| Platforms, Software and Systems | Major Function |
| Experience station 36 | A Tablet pc 130 or other mobile |
| | device 43PC/Net Book running |
| | on Android, iOS, or other platform. |
| Android SDK | Develop android application for |
| | scanning, synchronization etc. |
| Internal Scanning device or | For scanning the barcode 34 |
| camera or External Scanner | |
| SQL Lite | For local database on Android. |

### System Overview

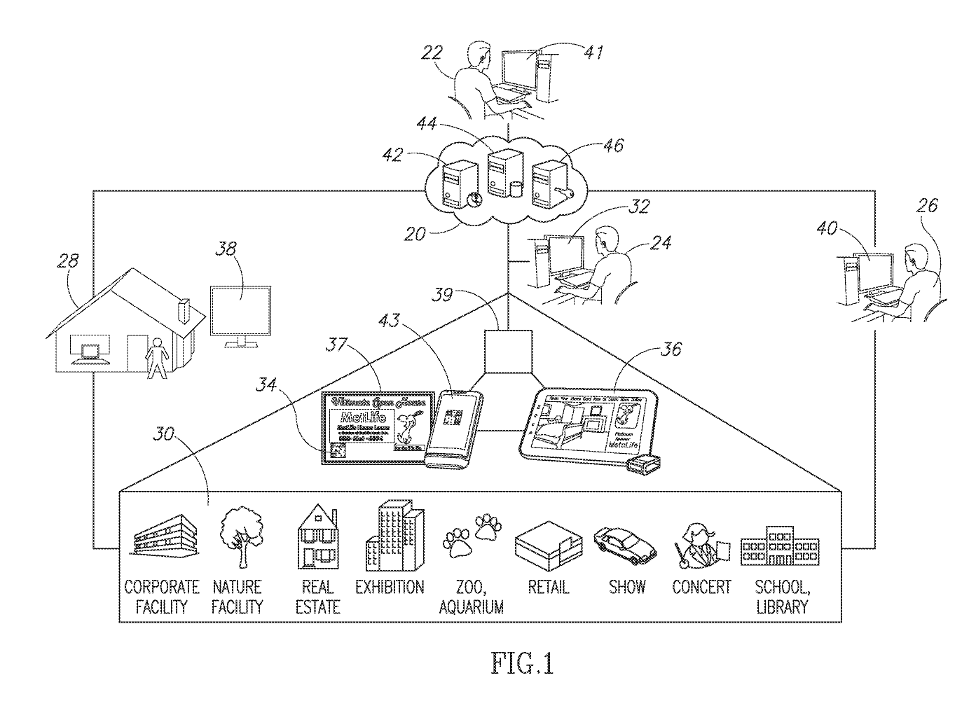

Referring to FIG. 1, the example embodiment is designed around four types of users: an administrator 22 (administrator); a client or venue owner 24 (venue owner); a sponsor, partner, advertiser, and/or content provider 26 (sponsor) 26; and a consumer or visitor 28 (visitor).

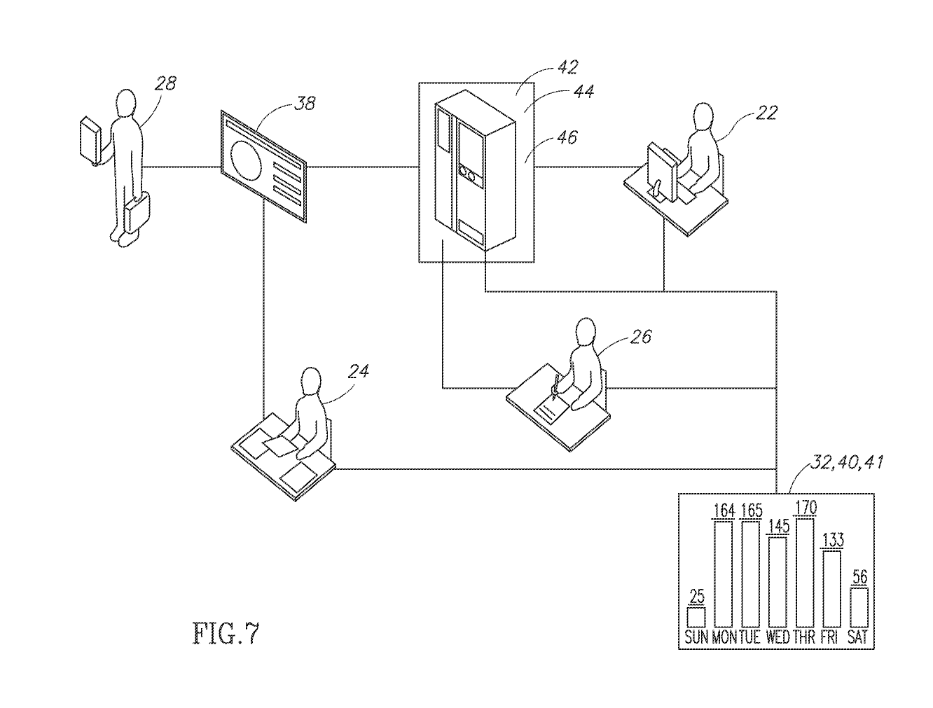

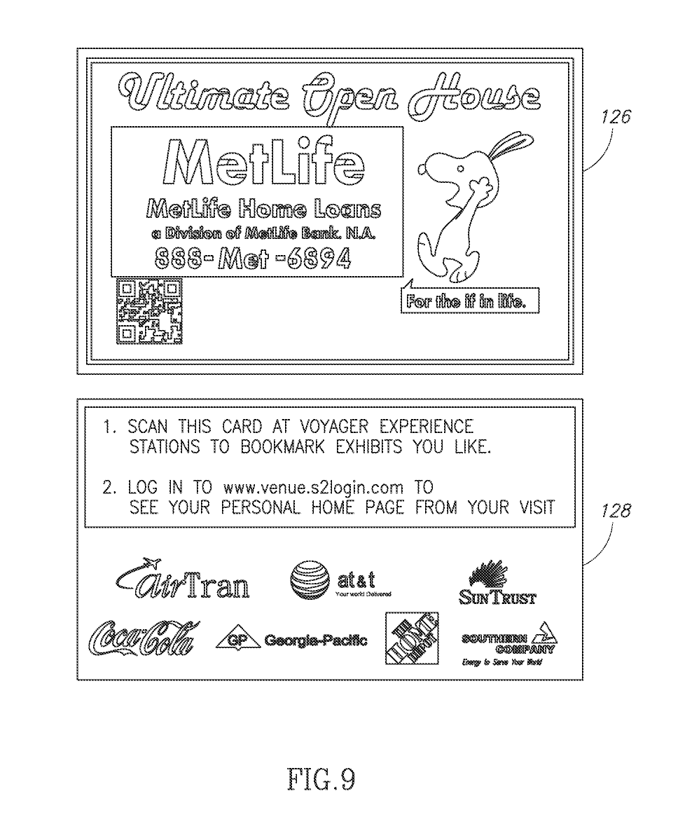

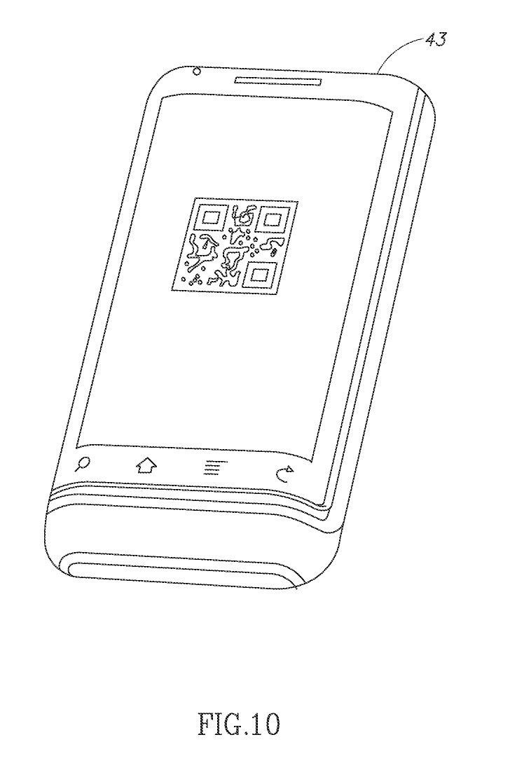

Referring to FIGS. 1 and 7, the venue owner 24 creates barcodes 34 or other machine-readable identifiers that can be printed on cards 37 or made available electronically (as in a download to a mobile device 43) or in other forms to visitors 28. Example machine-readable identifiers include one- or two-dimensional barcodes, radio frequency identifier (“RFID”) tags, or the like. FIG. 9 shows an exemplar card 37, which may serve as a personal but anonymous identifier that flexibly contains an array of content in addition to the barcode 34. Card or downloaded content may include advertisements, sponsor 26 logos, images, or other information provided by sponsors 26 or the venue owner 24.

As used herein, an “experience” includes something personally encountered, undergone or lived through. An experience station 36 is a device or posted scan code that a visitor 28 interacts with at a given time and place. By interacting with the experience station 36, the visitor 28 may identify an interest in something they have encountered, undergone or lived through. Experience stations 36 add to the venue or event experience by providing direct interaction with content at that place and time. The visitor 28 may scan the codes 34 in whatever form (printed or electronic) at experience stations 36 throughout the venue. Scanning a code in this manner creates a bookmark for that experience station 36. Data are collected to identify the location of the bookmark including, for example, information in the bar code 34, experience station, GPS or other location-identifying coordinates and interactive input. Other data may also be collected at this time as it relates to any device (e.g., mobile phone or other handheld devices) that may be used in the process for scanning and bookmarking. Data may also be generated at the experience station 36 via touch screen or other input devices. Later, at a different time and place, the visitor may use the code 34 and a URL they received to navigate to a homepage on the Internet. Once there, the bookmarks are preferably used to automatically create a customized homepage so that the visitor 28 may receive more content related to experience stations 36 at which they scanned their code 34.

Referring to FIGS. 1 and 5, the information scanned at experience stations 36 is preferably sent to a web server 42. The visitors 28 who scanned their codes 34 at an experience station, or who downloaded software to their own mobile device 43 to scan a code, may later register their card 37 and/or sign in with their downloaded code at a portal 38 where they receive information and experiences related to their visit to the venue as well as advertising and sponsor 26 offers.

Venue owners 24 preferably manage the onsite experiences and sponsor 26 offerings. Sponsors 26 may purchase advertising packages and upload their own content to the venue, advertising, research and management server 44.

The administrator 22 preferably has privileges to manage the entire system. A data and analytics server 46 provides reports to the client venue owner 24's portal 32, the partner sponsor 26 portal 40, and the administrator 22 portal 41.

### System and Processes

As noted above, in the preferred embodiment there are four entities (e.g., people, organizations) that interact within the system: network administrators 22, venue owners 24, sponsors 26 and visitors 28. These systems have three operational domains: network administration, onsite experience and online experience. The following sections describe the preferred role and experience of each entity within the context of each domain, as appropriate. It will be appreciated that the role and experience of each entity may vary depending upon the particular application of the techniques described herein.

### Operational Domain 1: Network Administration

Referring to FIG. 1, the network administrator 22 is the user on the top most layer of the network 20 that runs the system. The administrator 22 creates, manages and supports the entire network 20 operation. The administrator 22 has all rights to create, edit and delete.

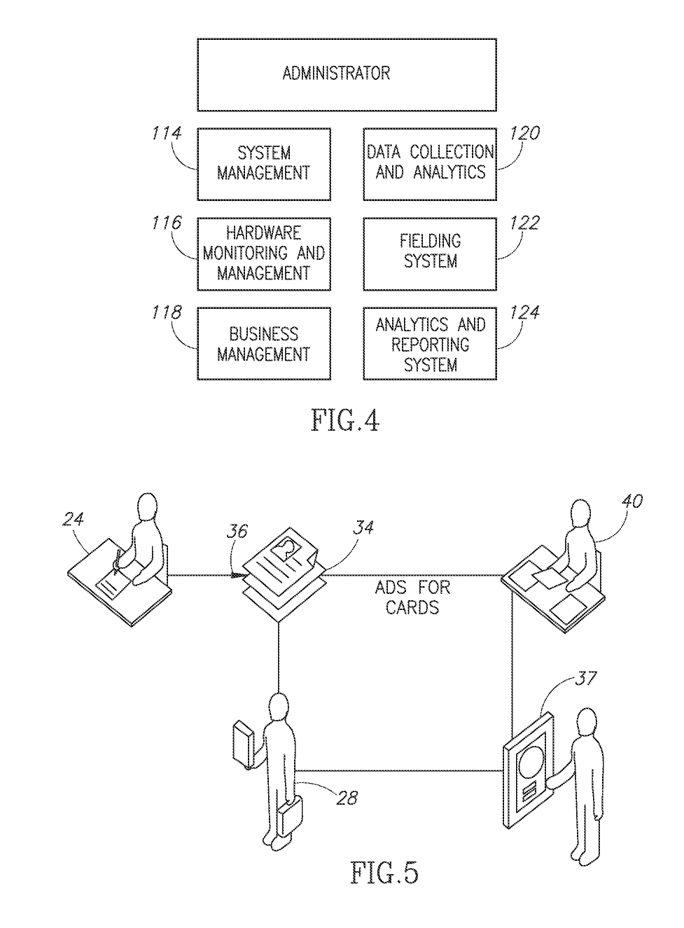

Referring to FIG. 4, in the preferred embodiment the administrator 22 manages six processes in the network administration domain through the network 20 of hosted servers, including systems management 114, hardware monitoring and management 116, business management 118, data collection and analytics 120, a research fielding system 122, and an analytics and reporting system 124.

Referring to FIG. 1, the network administrator 22 preferably connects to a network 20 of hosted servers using a network administration dashboard 41, which in this embodiment is a web application on a hosted/dedicated web server 42 preferably running on the Linux platform. Other server types and platforms may be used. Network 20 of hosted servers also contains a venue 30 management, advertising, research and management server 44 and a data analytics management server 46, all or any of which may run PHP and use MySQL databases or similar software to perform this function.

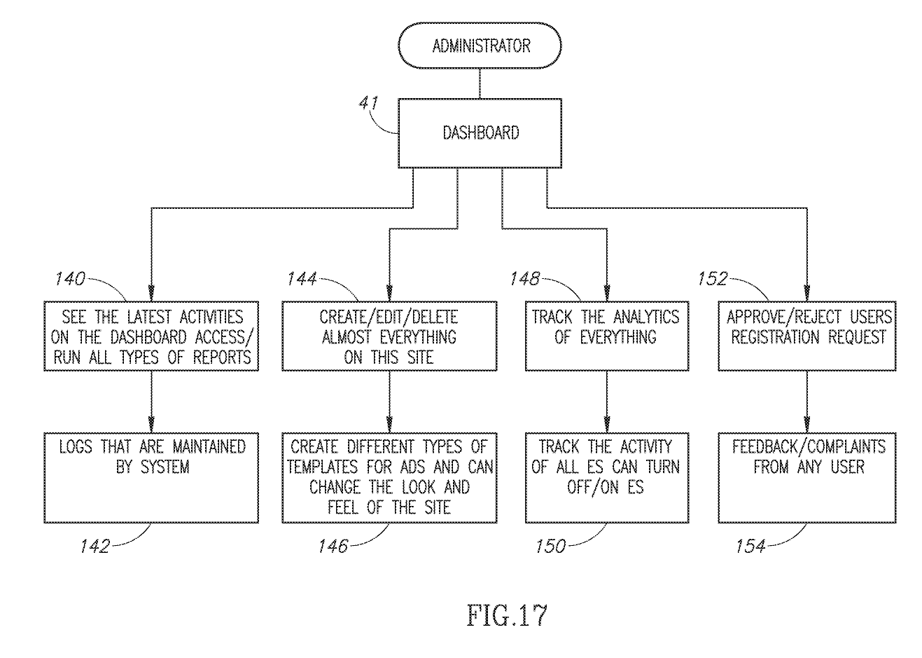

Referring to FIGS. 1 and 17, a dashboard 41 is preferably used to manage the network administrator's 22 administrative controls and processes based on software that is hosted on the network 20 as related to the management processes found in FIG. 4. Again, the dashboard 41 connects to the network 20 of hosted computers, which is a set of hosted/dedicated web servers preferably running on Linux platform for web applications. From the dashboard 41, the network 20 manager can perform a wide variety of functions, for example, access the latest activities 140, manage logs maintained by the system 142, create and edit sites and content 144, create templates for ads and the site 146, track analytics across the system 148, track experience stations 150, manage venue 30 approvals, manage venues 152, and receive and send feedback across the system 154.

The network administrator's system just described provides software to control numerous administrative functions and management processes including, without limitation:
System Management Operations
Log in to any account
Track and manage error logs
Send messages to any venue owner 24 or sponsor 26
Manage systems that host venue 30/sponsor 26/visitor 28 experiences
Add/edit/delete/monitor/manage hardware inventor
Manage and monitor a venue 30/sponsor 26/visitor 28 message center
Receive and reply to feedback/complaints
Provide and manage tools to generate barcodes 34
Provide and manage portal analytic tools for venue owner 24 and sponsor 26
Provide and manage experience station 36 analytic tools for venue owner 24 and sponsor 26
Provide and manage sponsor 26 advertising sales and management system
Provide and manage visitor 28 experience management system
Provide and manage all database functions on the network 20
Collect data about all users on the network 20
Conduct multivariate statistical analyses of network 20 data
Develop and run reports on system operations and user behaviors
Venues 30
Add/edit/manage/delete/approve visitors 28 and sponsors 26
Monitor and manage experience stations 36
Monitor and manage onsite operational hardware
Add/edit/delete/manage/approve content
Add/edit/manage/delete/monitor current and upcoming scheduled venue events
Provide venue content management system (CMS) for venue 30
Sponsors 26
Add/edit/delete/manage Ad packages availability and purchased status
Add/edit/delete All ad packages and their contents
Quick analytics/reports of advertising and sponsorship data
Provide sponsor 26 CMS for ad packages
Visitors 28
Add/edit/delete/manage
Manage visitors 28 and their approvals

By way of example, analytics available throughout the network 20 may include, without limitation:
User behavior tracking visits of visitors 28
Graphs/charts for comparing ad performance
Items bookmarked by visitors 28
Traffic details, month/day/week wise, etc.

Additional reports may be added as needed. These reports may include prompt values to allow the report to be pulled for a variety of date ranges and to control data returned to specific areas such as by genre, if needed. These reports may include venue-based data limits. The network administrator 22 may see all data for any reports.

### Operational Domain 2: Onsite Experience

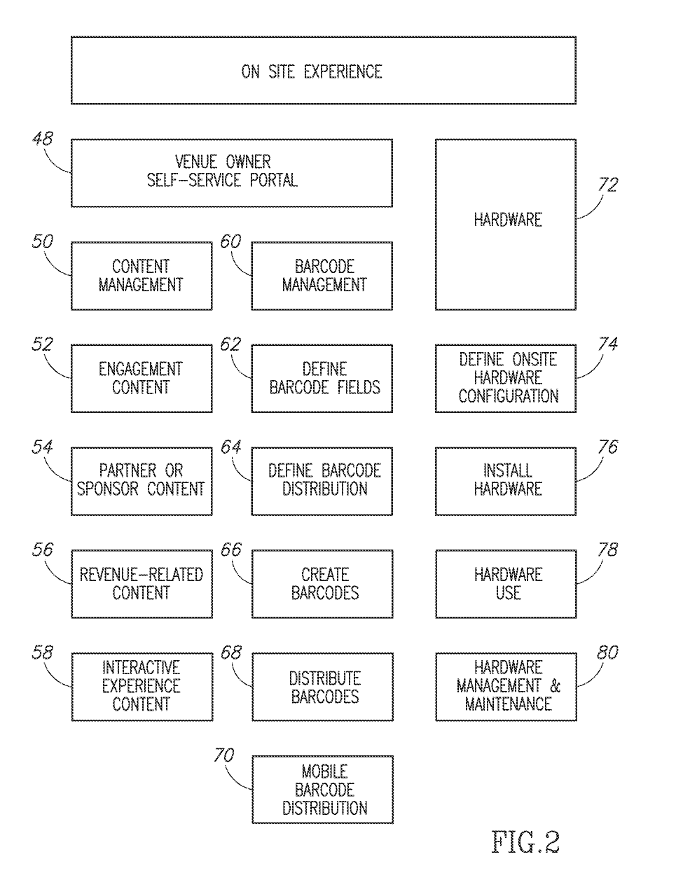

FIGS. 1 and 2 describe the activities and systems that the venue owner 24 uses in a preferred embodiment of the present invention. The venue owner 24 uses a portal 48 to control the following system functions: barcode 34 management 60, barcode 34 field definition 62, barcode 34 distribution definition 64, barcode 34 creation 66, barcode 34 distribution 68, and mobile barcode 34 distribution 70. The venue owner 24 also creates and manages various forms of content using a content management system 50. Content types that the venue Owner 24 manages include engagement content 52, partner or sponsor 26 content 54, revenue-related content 56, and interactive experience content 58.

The venue owner 24 also controls the onsite hardware 72, which preferably consists of a networked set of experience stations 36 and a control center 39. The experience stations 36 preferably use WiFi or wired (or other comparable technology) connections to connect to the control center 39. The control center 39 is connected to the through the venue's internal systems (or via wireless connect, for example, 3G/4G) to the Internet and ultimately to the network of hosted servers 20. The venue owner 24 uses this system to define the onsite hardware configuration 74, install hardware 76, define hardware use 78, and manage and maintain the hardware 80.

As an alternative or addition, the venue owner 24 may choose to enable visitors 28 to download mobile device experience station software preferably from the hosted servers to their personal mobile device 43 connected to a mobile network. The software effectively turns personal mobile devices into experience stations 36. Thereafter, the visitor 28 may scan codes 34 at locations throughout the venue 30. Upon scanning, the mobile device 43 may receive direct or indirect access to, without limitation, informative content, Internet URLs, and downloadable and non-downloadable interactive experiences.

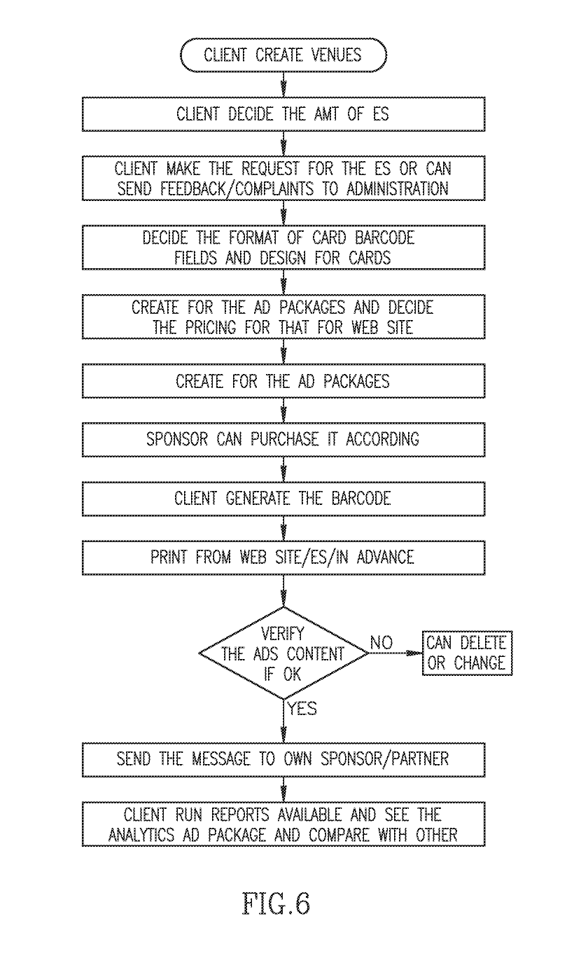

In a preferred embodiment, referring to FIG. 1 and the flowchart shown in FIG. 6, the venue owner 24 first logs into a venue owner portal 32 using a web browser. The venue portal 32 is the single point of interaction for the venue owner 24 where they can set up and manage the onsite and online experiences for the visitor 28 and the Sponsors 26. The portal is hosted on the network 20 of hosted computers via the Internet.

Stepwise, the venue owner 24 defines venues 30 where experience stations 36 are to be placed, and specifies the number of experience stations required to configure the experience. As with all specifications, the network administrator 22 has the authority to approve or reject any configurations as appropriate.

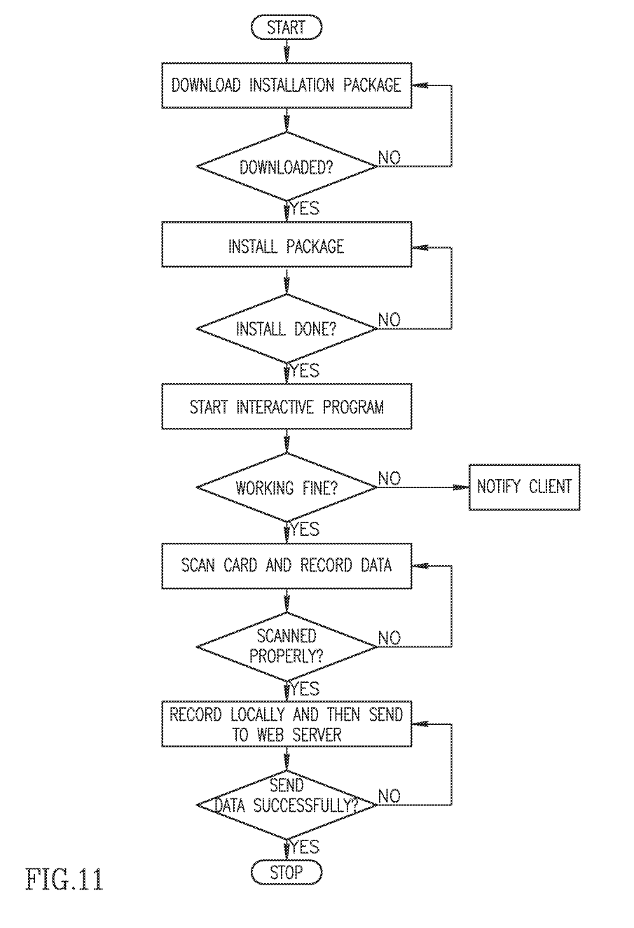

After creating venues 30, the client selects the format of card 37 and barcode 34 fields from a set of design templates for cards 37 or mobile devices 43 that are made available by the network administrator 22. FIG. 9 shows an exemplar of the card 37 and barcode 34. FIG. 10 shows an exemplar code 34 on a mobile device 43.

After selecting the format of the cards 37 or mobile devices 43, the venue owner 24 then creates ad packages and decides the pricing for sponsors 26. The sponsor 26 packages include placement of advertising or other information on the visitor portal 38, cards 37 and experience stations 36 in any possible combination of those options so that the sponsor 26 can purchase it according to pricing and different options available on the sponsor portal 40.

No specific hardware is required for venue owners 24 to use the online system. The portal 32 and all management activities may operate through any common browser including, without limitation, Internet Explorer, Mozilla Firefox, Google Chrome, etc.

The preferred venue owner 24's portal provides numerous administrative functions and management processes including, without limitation:
Add/edit/delete venues 30 in which they place experience stations 36
Add/edit/delete/approve ad packages sold to sponsors 26
Send messages to their sponsors 26 and visitors 28
Run system reports
Manage bar codes 34
Install and manage experience stations 36
Communicate with the administrator 22.
Management their account
Create and manage current and upcoming scheduled events.
Create quick analytics/reports.
Make hardware requests of the network administrator 22
Installation of experience station at for own venue.
Management of their own account

Barcode 34 and Card 37 Creation Process

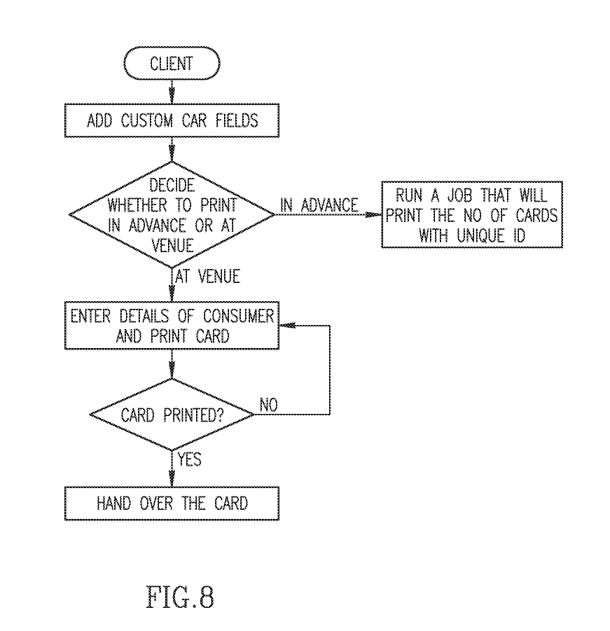

Referring to FIG. 1, the onsite experience preferably utilizes barcodes 34 to anonymously identify visitors 28. FIG. 8 shows the process by which venue owners 24 create codes 34 and cards 37 (or mobile device 43 configurations).

In the preferred embodiment, the barcodes 34 that a venue 30 creates are based on templates provided by the network administrator 22 to the venue owner 24 on their venue owner portal 32. A tool for barcode 34 creation contains basic information related barcodes 34. The network administrator 22 defines the basic fields for the barcode 34. Some of them can be changed by venue owner 24, but in the preferred embodiment specific fields that are created by network administrator 22 are compulsory for all. Venue owners 24 can edit/add new fields in barcode 34, this may be a one-time process or whenever required.

The system allows clients to print the cards 37 in advance as a batch job with each code 34 and card 37 containing a unique identifying code. This process is built into the venue portal 32 and the card 37 orders are processed by the network administrator 22 and sent to an outside vendor. Alternatively, the venue owner 24 may choose to produce the cards 37 themselves or through their own vendors. Also, the venue owner 24 may choose to provide the code 34 through an electronic download for visitors 28 so that they can get a scan code 34 on a mobile device 43 to use instead of a card 37. These electronically-delivered barcodes 34 are from the same database as the printed barcodes 34.

By way of example, the fields captured in the barcode 34 include, without limitation:
Card 37 ID
Event ID
Venue 30 ID
Card 37 Field ID
Created by
Updated by
Created date time
Updated date time

Experience Station 36 Configuration by Venue Owners 24 and Use by Visitors 28

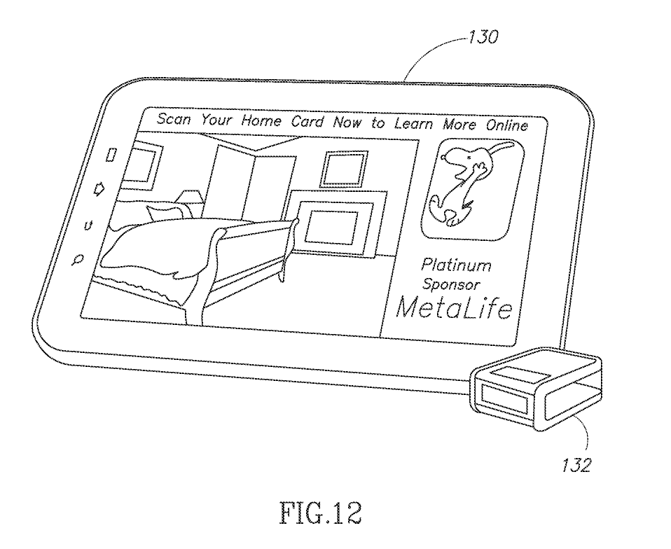

The experience station 36 is the central element of the onsite experience. FIG. 11 shows the preferred process by which these stations are created and used. FIG. 12 is an exemplar showing that the experience station 36 (FIG. 1) may be comprised of two components: a tablet pc 130 or other mobile device and scanner device, such as a barcode reader 132 that can preferably read 1-dimensional and 2-dimensional barcodes 34 used for the experience station 36. Any number of form factors may be used for this purpose (mobile devices, desktop computers, etc.). Moreover, the barcode reader 132 may be replaced with a camera that is either built into the tablet pc 130 or other mobile device 43 or is a separate input device (including, without limitation, mobile telephones or other wireless devices). The tablet pc 130 or other mobile device 43 links to a barcode reader 132. The tablet pc 130 or other mobile device 43 may have the capability to, without limitation, drive external devices (video, audio, USB, etc.) and to use external input devices (key pads, keyboards, etc.).

Referring to FIG. 2, the venue owner portal 32 connects to systems that provide the core tools creating and managing the visitor 28 and sponsor 26 experiences.

FIG. 11 shows the process by which the experience station 36 is preferably set up and used. In practice, whenever the visitor 28 comes with a barcode 34 and holds the card 37 or mobile device 43 containing an electronic scan code in front of scanning device 132, the scanning device 132 reads the data written inside the code 34 and records it in local database on the control station 39 first, and then the data are sent to the network computers 20, which depends upon the availability of connectivity. If there is no static connectivity, then venue owner 24 can push the data to a web server manually whenever the connectivity is available. Alternatively, the control station 39 can automatically send information when connection is available. In the preferred embodiment, every experience station will send the experience station ID, venue ID, card ID, GPS location (if available) at the time of scanning the card 37.

Alternatively, the experience station 36 can be augmented or replaced by a mobile device owned by the visitor 28. In this scenario, the mobile phone owner acquires an application (usually through download) that runs on their personal mobile device 43 This application can, without limitation, provide an electronic code to the visitor's device, and/or enable their device to become the experience station from which visitors can scan codes posted at the venue.

Each experience station 36 or personal mobile device 43 may be identified by a set of data fields including, without limitation:
Experience station 36 ID
Experience station 36 name
Station type
Experience description
Created by
Updated by
Created date time
Updated date time

### Operational Domain 3: Online Experience

Venue Owner 24 Creating the Visitor 28 Online Experience

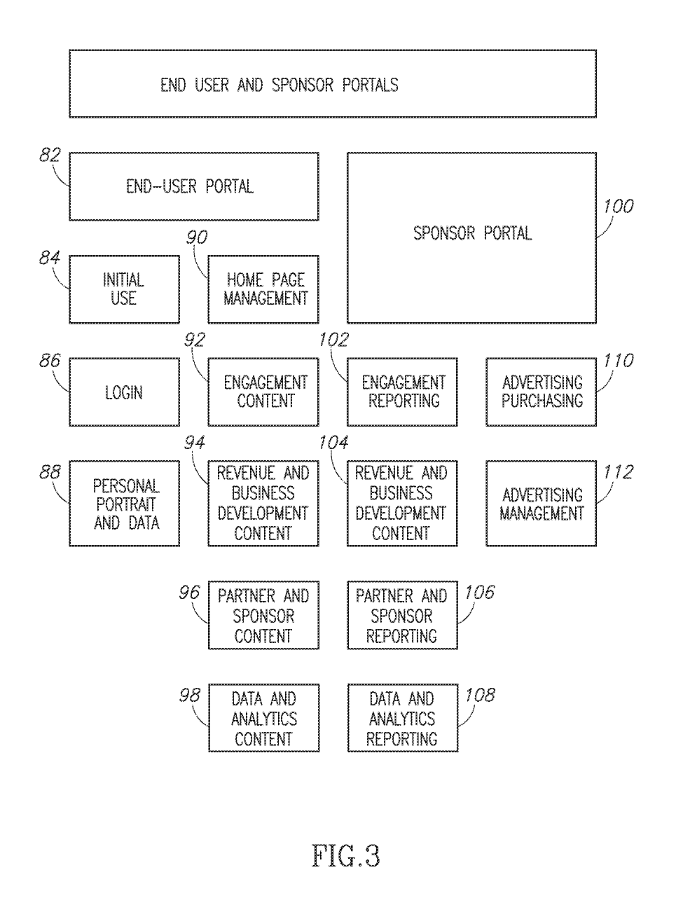

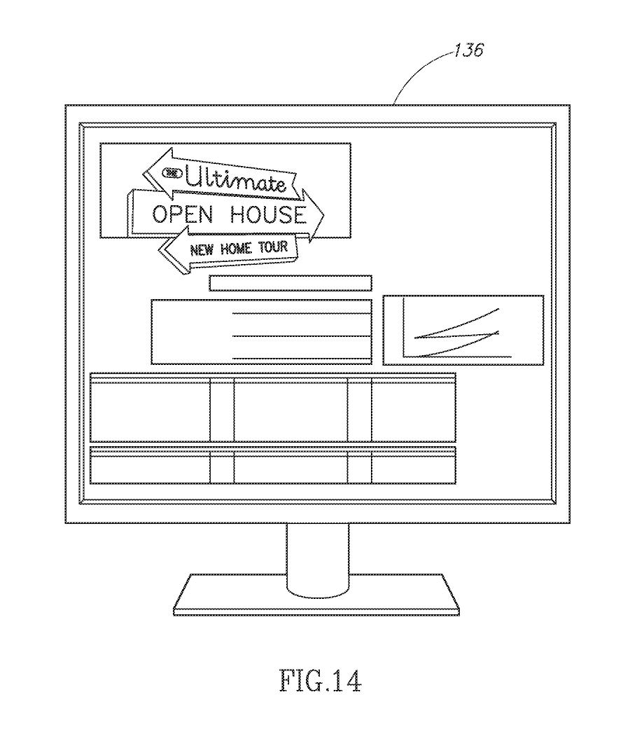

Referring to FIG. 1, the venue owner 24 creates and manages the online experiences for visitors 28 and sponsors 26 using their venue owner portal 32. Referring to FIG. 3, there are a number of processes that the venue owner 24 manages. FIG. 14 shows a sample screen 136 of the control portals for the venue owner 24, sponsor 26, and the network administrator 22.

FIG. 3 shows the preferred processes and actions that the venue owner 24 manages through the visitor portal 38. The venue owner 24 creates a home page 90, and populates the site with engagement content 90 related to the onsite experience at the venue 30. In addition the venue owner 24 specifies the parameters and use of revenue and business development content 94 that the venue 30 can use to generate revenue for itself. The venue owner 24 configures the capabilities for the partner and sponsor content 96. The venue owner 24 also preferably defines and creates users settings such as the visitor 28's initial use experience 84, login process 86, and the opportunity for visitors 28 to share personal profile and other information 88.

Visitor 28 Online Experience

Visitors 28 who scan their barcode 34 or use their personal mobile devices 43 as code readers at venue 30 create a virtual set of bookmarks of their experience. This set of bookmarks may initially held onsite in the control station 39, after which the data are replicated on a server on the network 20 or alternative processing or storage location. Alternatively, they may be directly sent to the database servers 20 directly from experience stations 36 and personal mobile devices 43. At this point, the visitor 28's experience is in transition from one based at the experience location to one based online.

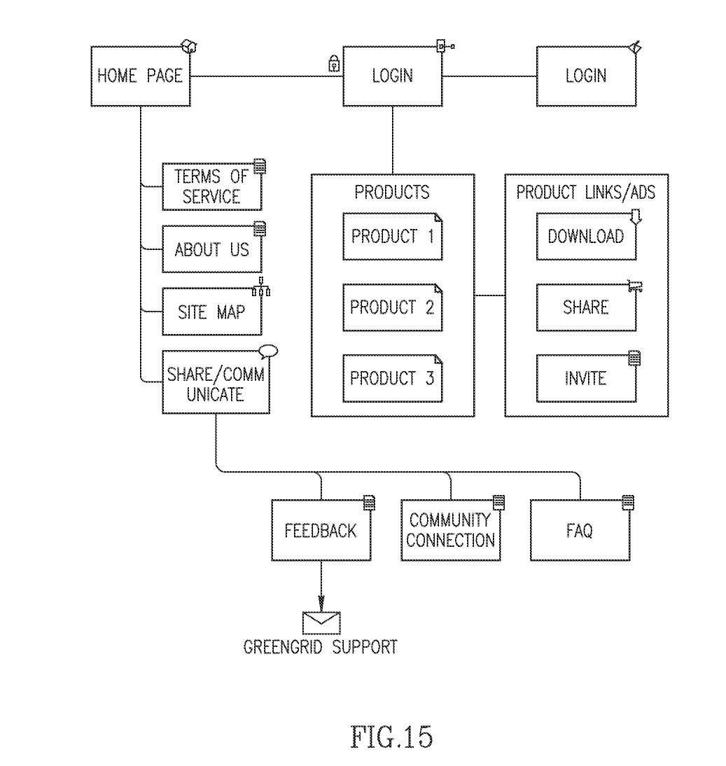

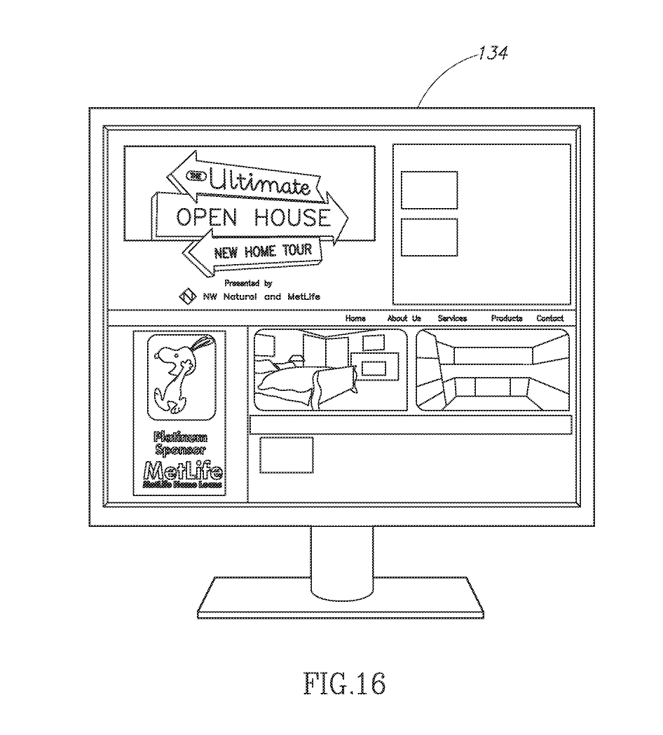

Later, visitors 28 can sign-in to a visitor 28 portal (e.g., website) that creates a custom homepage for each visitor 28 based on their personal, anonymous bookmark data captured at the venue 30. From here visitors 28 can re-connect, re-visit, and again engage with and experience the venue 30 and its sponsors 26. FIG. 15 contains a high-level schematic of the visitor portal 38. FIG. 16 contains a conceptual image of the visitor portal 38. This experience may take place on any computing device that is connected to the Internet.

Referring to FIG. 1, the visitor 28's online experience preferably starts with registering on the visitor portal 38 by using a URL that they receive when they obtain their barcode 34. They use their barcode 34 that was given to them on a card 37 or device 43 at the Venue 30 to create a login. They may then be asked to provide information at the discretion of the venue owner 24. The visitor 28 can reach the website from anywhere in world and register on the visitor portal 38, for example by following some simple steps using information related to their barcode 34 by following instructions printed on their card 37 as shown in the image in FIG. 9. Preferably, except for card number from the barcode 34 on the card 37, everything on the registration form that the venue owner 24 uses may be customized to enable the visitor 28 to create a unique log in on the site, provide personal information, or take other preauthorized action.

After successful log in a user will be presented with a home page and portal 38; an exemplar image is shown in FIG. 16. The portal is the continuation of the onsite experience at the venue 30. The purpose is to reconnect the visitor 28 to the experience, and provide content and offers that are germane.

Once on the visitor portal 38, visitors 28 may engage in processes that may include, without limitation:
Registration
Account management
Aggregate cards 37 from multiple venues 30 or people
Password reset
See information (images, other content) that relates to the experience stations 36 that were scanned at the venue 30.
Access links related to the sponsors 26
Browse and access site content
Can go to venue virtually through online experiences
Share links on different social networking sites, or invite friends to a venue 30's site.
Receive updated information on venue events or sponsor 26 offers
Sponsor 26 online experience

Sponsor 26 Online Experience

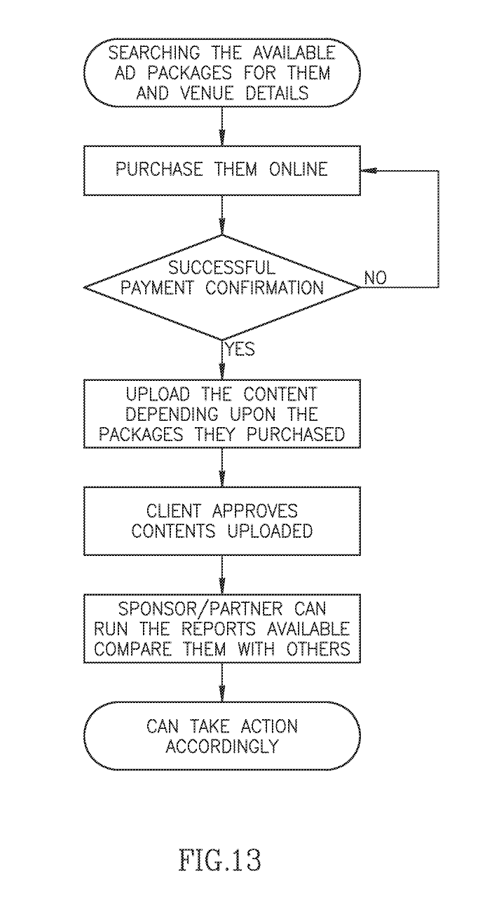

The flowchart in FIG. 13 shows a preferred sponsor 26 process. The sponsor 26 process starts with searching the available ad packages for them and venue details. Sponsors 26 may be able to select offers from one or more venues 30, depending on the venue 30's decision to participate in an open offering. Sponsors 26 may use the sponsor portal 40 to register and login and then review details of sponsorship opportunities from the venues 30. The sponsor 26 can select and purchase an ad package through the sponsor portal 40. Later, they can use the same portal to upload content, monitor, and manage their advertising and sponsorship information. The purchase system uses PayPal or a similar payment service as back end billing/invoicing/payment system.

The sponsor portal 40 just described provides numerous administrative functions and management processes including, without limitation:
Add/edit/delete ad purchased packages
Add/modify/delete ad contents of own subject to approval by venue owner 24
Run analytic reports
Account management
Exchange messages with venue owner 24.

### Components

In a preferred embodiment, the system components may include the following:

### FIG. 1 Experience Schematic

20 Network of Hosted Servers
22 Network Administrator
24 Client, Venue Owner Administrator
26 Sponsor, Partner, Advertiser, Content Provider Administrator
28 Consumer, Visitor
30 Venues
32 Client, Venue Owner Portal
34 Barcode
36 Venue Experience Station
37 Experience Card
38 Consumer, Visitor Portal
39 Control Station
40 Sponsor Portal
41 Network Administrator Dashboard
42 Web Server
44 Venue, Advertising, Research, Management Server
46 Data, Analytics Management Server

### FIG. 2 Online Process Management Chart

48 Venue Owner Self Service Portal
50 Content Management
52 Engagement Management
54 Partner or Sponsor Content
56 Revenue-Related Content
58 Interactive Experience Content
60 Barcode Management
62 Define Barcode Fields
64 Define Barcode Distribution
66 Create Barcodes
68 Distribute Barcodes
70 Mobile Barcode Distribution
72 Hardware
74 Define onsite Hardware Configuration
76 Install Hardware
78 Hardware Use
80 Hardware Management and Maintenance

### FIG. 3 End User and Sponsor Portals

82 End-User Portal
84 Initial Use
86 Login
88 Personal Portrait and Data
90 Home Page Management
92 Engagement Content
94 Revenue and Business Development Content
96 Partner and Sponsor Content
98 Data and Analytics Content
100 Sponsor Portal
102 Engagement Reporting
104 Revenue and Business Development Reporting
106 Partner and Sponsor Reporting
108 Data and Analytics Reporting
110 Advertising Purchasing
112 Advertising Management

### FIG. 4 Administrator Major Components and Processes

114 Systems Management
116 Hardware Monitoring and Management
118 Business Management
120 Data Collection and Analytics
122 Fielding System
124 Analytics and Reporting System

### FIG. 5 Online Flowchart Schematic

22 Network Administrator
24 Venue Owner
26 Sponsor
28 Visitor
32 Venue Owner Portal
38 Visitor Portal/Web Site
40 Sponsor Portal
41 Network Administrator Portal
42 Web Server
44 Venue, Advertising, Research, Management Server
46 Data, Analytics, Management Server

### FIG. 7 Onsite Flow Schematic

24 Client, Venue Owner Administrator
28 Consumer, Visitor
34 Barcode
36 Experience Card
37 Venue Experience Station
40 Sponsor, Partner, Advertiser, Content Provider Administrator Portal

### FIG. 9 Experience Card Image

126 Experience Card Front
128 Experience Card Back

### FIG. 10 Mobile Device Image

43 Mobile Device

### FIG. 12 Experience Station

130 Interactive Tablet PC
132 Barcode Reader

### FIG. 14 Network Manager, Venue Owner, Sponsor Portals

136 Management Portal

### FIG. 16 Visitor Portal

134 Visitor Portal

### FIG. 17 Administrator Schematic

138 Dashboard
140 Latest Activities in System
142 Logs maintained by the System
144 Create and Edit Sites and Content
146 Create Templates for ads and the site
148 Track Analytics across the system
150 Track Experience Stations
152 Approvals for clients, venues
154 Feedback handling

One embodiment includes a process for providing online experiences based on onsite visitor experiences. The process includes providing a visitor identifier to a visitor to a venue; associating a location identifier with each of multiple points of interest in the venue; receiving an indication that the visitor has expressed interest in one of the multiple points of interest, the received indication including the visitor identifier; and after the visitor has left the venue, providing the visitor with online content related to the one point of interest.

Another embodiment provides a system that includes hardware (e.g., a processor, memory) configured to execute a module configured to provide any of the above-described processes.

Another embodiment provides a computer-readable medium that includes contents (e.g., instructions) that are configured, when executed by a processor, to perform any of the above-described methods.

In an example embodiment, the described techniques may be implemented using standard programming techniques. For example, the components or modules may be implemented as “native” executables running on a CPU or other processor, along with one or more static or dynamic libraries. In other embodiments, modules may be implemented as instructions processed by a virtual machine that executes as a program on a CPU. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in certain embodiments, some or all of the described components may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for providing online experiences based on onsite visitor experiences, comprising:
providing a visitor identifier to a visitor to a venue;
associating a location identifier with each of multiple points of interest in the venue;
receiving an indication that the visitor has expressed interest in one of the multiple points of interest, the received indication including the visitor identifier; and
providing the visitor with online content related to the one point of interest.

2. The method of claim 1, wherein providing the visitor identifier to the visitor includes providing the visitor with a card that includes a barcode that represents the visitor identifier.

3. The method of claim 1, wherein providing the visitor identifier to the visitor includes transmitting a barcode to a mobile device of the visitor.

4. The method of claim 1, wherein providing the visitor identifier to the visitor includes transmitting a code module to a mobile device of the visitor, the code module configured to scan barcodes associated with points of interests within the venue.

5. The method of claim 1, wherein associating the location identifier with each of multiple points of interest includes causing a scanning station to be installed at each of the multiple points of interest, each scanning station configured to scan a visitor identifier and to transmit the scanned visitor identifier along with the location identifier associated with the corresponding point of interest.

6. The method of claim 1, wherein associating the location identifier with each of multiple points of interest includes causing a barcode to be installed at each of the multiple points of interest, each barcode encoding the location identifier associated with the corresponding point of interest.

7. The method of claim 1, wherein associating the location identifier with each of multiple points of interest includes storing a GPS location in association with each of the multiple points of interest.

8. The method of claim 1, wherein receiving an indication that the visitor has expressed interest in one of the multiple points of interest includes receiving the indication from a scanning station associated with the one point of interest.

9. The method of claim 1, wherein receiving an indication that the visitor has expressed interest in one of the multiple points of interest includes receiving the indication from a mobile device of the visitor.

10. The method of claim 9, wherein the received indication includes a GPS coordinate provided by the mobile device, and further comprising identifying the one point of interest as the point of interest that is nearest to the received GPS coordinate.

11. The method of claim 1, wherein providing the visitor with online content related to the one point of interest includes providing a web site customized based on points of interest in which the visitor has expressed interest, the web site including links to or information from sponsors associated with the points of interest and/or advertisements related to the points of interest.

12. The method of claim 1, further comprising receiving the content related to the one point of interest from a sponsor associated with the one point of interest.

13. The method of claim 1, further comprising providing analytics information related to the venue, the analytics information based at least in part on multiple indications each indicating an expression of interest by a visitor in one or more of the multiple points of interest.

14. The method of claim 13, wherein providing analytics information related to the venue includes providing to a sponsor associated with the one point of interest information about how many visitors expressed interest in the one point of interest.

15. The method of claim 1 wherein the venue is one or more of: a corporate facility, a nature facility, real property available for purchase or lease, an exhibition, a convention, a conference, a zoo, an aquarium, a retail establishment, a concert, a gallery, a museum, or a library.

16. A computer-readable medium including contents that, when executed by a computing system, cause the computing system to provide online experiences based on onsite visitor experiences, by performing a method comprising:
providing a visitor identifier to a visitor to a venue;
associating a location identifier with each of multiple points of interest in the venue;
receiving an indication that the visitor has expressed interest in one of the multiple points of interest, the received indication including the visitor identifier; and
providing the visitor with online content related to the one point of interest.

17. The computer-readable medium of claim 16 wherein the computer-readable medium is a memory in the computing system and wherein the contents are instructions that, when executed, cause the computing system to perform the method.

18. A system for providing online experiences based on onsite visitor experiences, the system comprising:
a processor;
a memory;
a module that is stored on the memory and that is configured, when executed by the processor, to:
provide a visitor identifier to a visitor to a venue;
associate a location identifier with each of multiple points of interest in the venue;
receive an indication that the visitor has expressed interest in one of the multiple points of interest, the received indication including the visitor identifier; and
after the visitor has left the venue, provide the visitor with online content related to the one point of interest.

19. The system of claim 18, further comprising multiple devices that are located at the venue, that are in communication with the module, and that are each configured to transmit an indication that a visitor has expressed interest in one of the multiple points of interest.

20. The system of claim 19 wherein at least some of the multiple devices are mobile devices that are each configured to transmit the indication to the module, based on a scan of a barcode associated with a point of interest and/or a GPS coordinate determined by the smart phone.
